(19) United States
(12) Patent Application Publication
(10) Pub. No.: US 2015/0224351 A1
(43) Pub. Date: Aug. 13, 2015

(54) FIRE SPRINKLER CAPABLE OF DETECTING A HIGH TEMPERATURE IN A SHORT TIME

(71) Applicant: PROTECTOR SAFETY IND., LTD., Taoyuan County (TW)

(72) Inventor: Jung-Wen Chen, Taoyuan County (TW)

(73) Assignee: PROTECTOR SAFETY IND., LTD., Taoyuan County (TW)

(21) Appl. No.: 14/244,897

(22) Filed: Apr. 4, 2014

(30) Foreign Application Priority Data
Feb. 13, 2014 (TW) 103202511

(51) Int. Cl. A62C 37/11; A62C 35/68

(52) U.S. Cl. CPC A62C 37/11; A62C 35/68

(57) ABSTRACT

A fire sprinkler comprises a water supply pipe, a valve body, a heat-activated glass bulb, and a covering means. The valve body defines a passage having an inlet and an outlet at two ends thereof, wherein the inlet of the passage is connected with the water supply pipe. The heat-activated glass bulb is mounted in the valve body, wherein the heat-activated glass bulb is capable of closing the outlet of the passage when in normal condition. The covering means is arranged at a periphery of the valve body, wherein the covering means defines at least one through hole that facilitates the hot air generated in a fire emergency to contact the heat-activated glass bulb. With the fire sprinkler, the temperature response capability of the heat-activated glass bulb can be increased.

### TECHNICAL FIELD OF THE INVENTION The present invention relates to a fire sprinkler and, more particularly, to a fire sprinkler that can detect a high temperature in a fire emergency more quickly.

### DESCRIPTION OF THE PRIOR ART

For a room with a suspended ceiling, the space above the ceiling (referred to as “upper space”) is usually used for arranging electrical wires and fire pipes, and the space below the suspended ceiling (referred to as “lower space”) can serve as a living room, an office, a warehouse or a parking garage, which are usually provided with windows, doors or corridors, so that they are allowed to communicate with the outside environment. For most of the existing fire sprinklers, their valve bodies are installed in the upper space.

Generally, the existing fire sprinklers can be classified into three different types: concealed type, semi-concealed type, and open type. For a concealed fire sprinkler, its valve body and associated fire pipe are installed in the upper space and concealed by a decorative cover being arranged under the suspended ceiling. For a semi-concealed fire sprinkler, its valve body is installed in the lower space, and its associated fire pipe is installed in the upper space and concealed by a decorative cover. For an open-type fire sprinkler, its valve body and associated fire pipe are installed near the top surface of a room which is lack of a suspended ceiling. Such type of fire sprinkler is commonly applied in parking garages.

Typically, the existing fire sprinklers include a heat-activated glass bulb, which is a hollow glass bulb that contains a liquid being susceptible to thermal expansion (for example: alcohol or glycerin). The heat-activated glass bulb is mounted in the valve body. In normal condition, the glass bulb will close the outlet of the valve body. When a fire emergency occurs, the liquid will expand, and this will cause the glass bulb to break. Thus, the outlet of the valve body can be opened to allow the water of the fire pipe to flow out.

Due to the lower space of a room being able to communicate with the outside environment through its associated windows, doors or corridors (this is known as natural ventilation), the lower space will have a higher temperature than the upper space.

Furthermore, in a fire emergency, the fire source is usually found in the lower space of a mom. The hot air generated in the lower space will have the potentiality to flow upward. The hot air will flow from a low temperature zone to a high temperature zone.

Nevertheless, the smoke and heat generated in a fire emergency will be slowly accumulated in the lower space provided that the air communication between the upper space and the lower space is not good. Because of this reason, the heat transfer from the fire source to the heat-activated glass bulb may be retarded. Thus, for reducing the damages of a fire emergency, there is a need to develop a fire sprinkler that can mitigate the disadvantage of the existing fire sprinklers to shorten the response time of the glass bulb associated therewith.

### SUMMARY OF THE INVENTION

In view of the foregoing, the primary object of the present invention is to provide a fire sprinkler that can mitigate the disadvantage of the existing fire sprinklers to improve the temperature response of its glass bulb based on the air characteristics, namely that hot air have the potentiality to flow upward and can flow from a high pressure zone to a low pressure zone. To achieve the object of the present invention, applicant contrives technical means for the fire sprinkler, which generally comprises a water supply pipe, a valve body, a heat-activated glass bulb, and a covering means. The valve body defines a passage having an inlet and an outlet at two ends thereof, wherein the inlet of the passage is connected with the water supply pipe. The heat-activated glass bulb is mounted in the valve body, wherein the heat-activated glass bulb is capable of closing the outlet of the passage when in normal condition. The covering means is arranged at a periphery of the valve body, wherein the covering means defines at least one through hole that facilitates the hot air generated in a fire emergency to contact the heat-activated glass bulb.

According to one feature of the present invention, the covering means defines at least one through hole that allows the hot air generated in a fire emergency to be rapidly directed towards the heat-activated glass bulb, so that the contact between the hot air and the glass bulb can be increased. Therefore, the capability of the heat-activated glass bulb to respond to a high temperature can be increased.

According to another feature of the present invention, the fire sprinkler can be installed to cooperate with a suspended ceiling that separates a mom into an upper compartment and a lower compartment, wherein the valve body is substantially mounted in the upper compartment whereas the covering means is arranged in the lower compartment and adjacent to a bottom of the valve body, whereby the through hole of the covering means facilitates the hot air in the lower compartment to contact the heat-activated glass bulb. As such, when a fire emergency occurs, due to hot air being able to flow upward and being able to flow from a high pressure zone to a low pressure zone, the hot air generated in the lower compartment will rapidly flow from the lower compartment to the upper compartment, so that the contact between the glass bulb and the hot air can be increased, so that the temperature of the glass bulb can be increased rapidly, thereby reducing the time required for activating the fire sprinkler to spray water.

According to a further feature of the present invention, the fire sprinkler further comprises an outer shell being mounted around the valve body for protecting the heat-activated glass bulb, wherein the outer shell is bonded to the covering means through a low melting-point metal provided between a bottom of the outer shell and the covering means. Moreover, the outer shell defines at least one ventilation hole that facilitates the hot air in the upper compartment to contact the heat-activated glass bulb. As such, the hot air generated in a fire emergency can pass the outer shell rapidly to contact the glass bulb, so that the temperature of the glass bulb can be increased rapidly, and the time required for breaking the glass bulb can be reduced, so that the capability of the fire sprinkler to detect a high temperature can be increased.

According to a still further feature of the present invention, the fire sprinkler is installed to cooperate with a suspended ceiling that separates a mom into an upper compartment and a lower compartment, wherein the valve body is substantially mounted in the lower compartment and the heat-activated glass bulb is exposed in the lower compartment, the covering means is made in the form of a bell-shaped decorative cover being mounted between the heat-activated glass bulb and the suspended ceiling. As such, the contact between the glass bulb and the hot air can be increased, so that the capability of the heat-activated glass bulb to respond to a high temperature can be increased.

According to a still further of the present invention, the covering means is installed to cooperate with a suspended ceiling that separates a room into an upper compartment and a lower compartment, wherein the covering means includes an inner cover and an outer cover which encases the inner cover, wherein the inner cover is engaged with the valve body whereas the outer cover is adjustably engaged with the inner cover. As such, the outer cover can be properly fitted with the suspended ceiling by adjusting the outer cover to improve the overall appearance of the suspended ceiling.

According to a still further feature of the present invention, the through hole of the covering means and the ventilation hole of the outer shell are each configured to have a geometrical shape to improve the appearance of the fire sprinkler in addition to the ventilation function.

According to a still further feature of the present invention, the covering means is formed with an air-guiding plate extending downwardly from an edge of the through hole for guiding the hot air generated in a fire emergency to aim at the through hole. As such, the hot air passing the covering means via the through hole can be increased.

Other objects, advantages, and novel features of the present invention will become more apparent from the following detailed description when taken in conjunction with the accompanying drawings.

### BRIEF DESCRIPTION OF THE DRAWINGS

FIG. 1 shows a 3-dimensional exploded view of a first embodiment of the present invention.

FIG. 2 shows a 3-dimensional assembled view of the first embodiment of the present invention.

FIG. 3 shows a sectional view of the first embodiment of the present invention.

FIG. 4 shows a 3-dimensional assembled view of a second embodiment of the present invention.

FIG. 5 shows a sectional view of a third embodiment of the present invention.

FIG. 6 shows a sectional view of a fourth embodiment of the present invention.

FIG. 7 shows a top view of a disk-like decorative cover used in the present invention.

FIG. 8 shows a sectional view of the decorative cover taken along line A-A in FIG. 7.

### DETAILED DESCRIPTION OF THE PREFERRED EMBODIMENTS

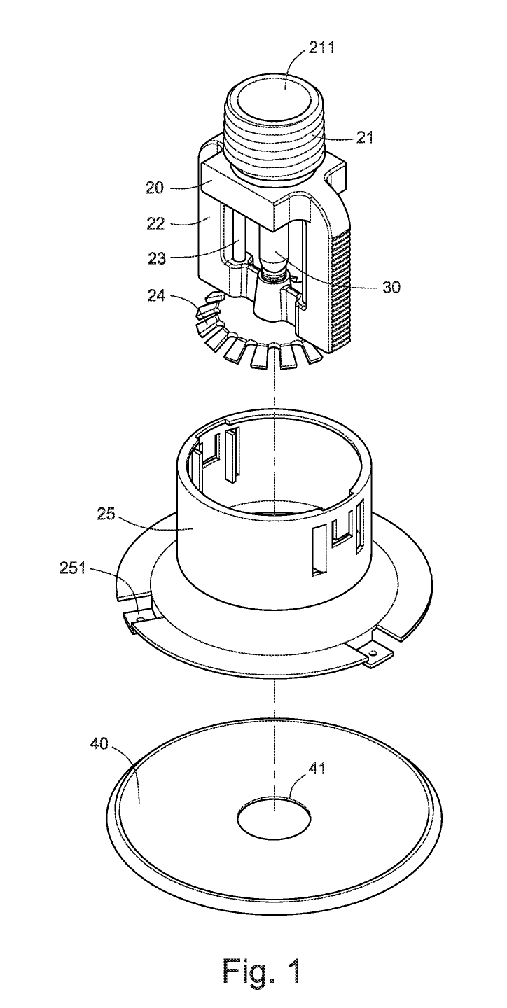

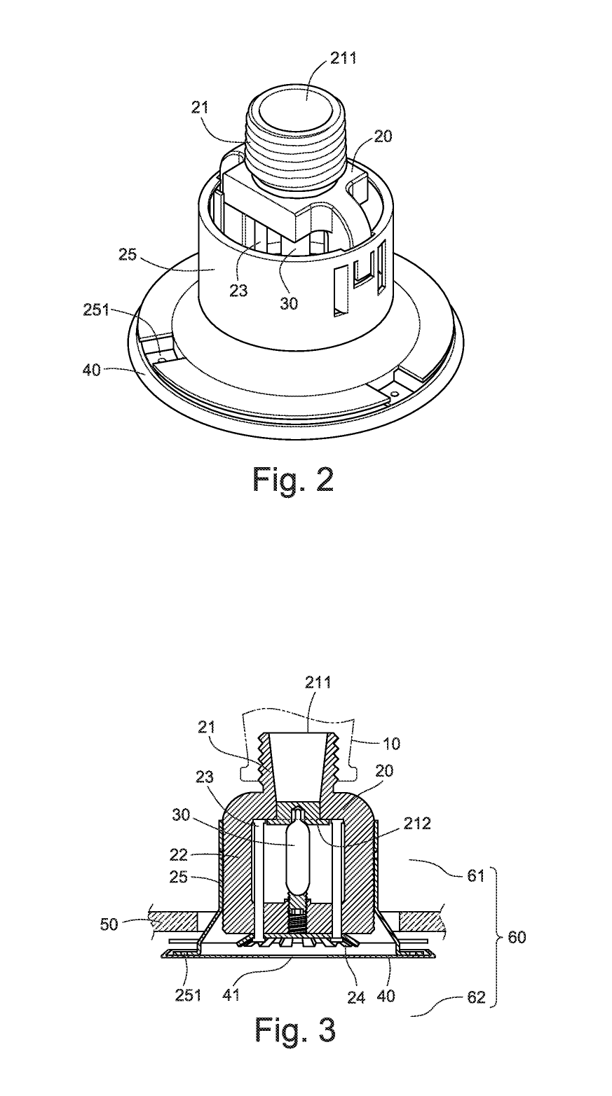

Referring to FIGS. 1 through 3, a fire sprinkler according to a first embodiment of the present invention is shown, wherein the fire sprinkler generally comprises a water supply pipe 10, a valve body 20, a heat-activated glass bulb 30, and a covering means 40. In this embodiment, the covering means 40 is made in the form of a disk-like decorative cover.

As shown, the valve body 20 defines a passage 21 which has an inlet 211 and an outlet 212 at two ends thereof. The inlet 211 of the passage 21 is connected with the water supply pipe 10. The valve body 20 uses the passage 21 to control water flowing from the water supply pipe 10. The valve body 20 is provided with two opposing bars 22 that substantially constitute a frame being used to support the glass bulb 30. In normal condition, the glass bulb 30 will close the outlet 212 of the passage 21 through a cap to prevent the water contained in the pipe 10 from flowing out. The frame, being substantially formed by the opposing bars 22, is provided at its bottom with two slidable posts 23 being connected to a disk-like deflector 24. With such feature, when a fire emergency occurs, water can flow from the outlet 212 of the passage 21 to impact the deflector 24 to produce a specific water spray pattern, which can increase the water distribution area. Moreover, the decorative cover 40 is mounted at a periphery of the valve body 20, wherein the decorative cover 40 defines at least one through hole 41, which can take shape through a punching operation, to facilitate the hot air generated in a fire emergency to rapidly contact the heat-activated glass bulb 30, so that the temperature of the glass bulb 30 can be rapidly increased. The through hole 41 of decorative cover 40 can be configured to have a geometrical shape. In FIG. 1, the through hole 41 of the decorative cover 40 is configured to be a round hole.

In this embodiment, as shown in FIG. 3, the valve body 20 of the fire sprinkler is substantially installed above a suspended ceiling 50. To describe in more detail, the fire sprinkler is installed to cooperate with the suspended ceiling 50, which separates a room space 60 into an upper compartment 61 and a lower compartment 62, wherein the valve body 20 is substantially mounted in the upper compartment 61 whereas the disk-like decorative cover 40 is arranged in the lower compartment 62 and adjacent to a bottom of the valve body 20. As such, the through hole 41 of the decorative cover 40 can facilitate the air in the lower compartment 62 to flow upward to contact the heat-activated glass bulb 30. With the through hole 41 of the decorative cover 40, the upper compartment 61 can communicate with the lower compartment 62 more effectively. As a result, the through hole 41 can facilitate the air in the lower compartment 62, especially the hot air generated in a fire emergency, to flow into the upper compartment 61 to contact the heat-activated glass bulb 30. Therefore, the time required for breaking the heat-activated glass bulb 30 can be shortened.

As shown in FIGS. 1 through 3, this embodiment is further provided with a cylindrical outer shell 25, which is mounted around the valve body 20 and engaged with the opposing bars 22 for protecting the heat-activated glass bulb 30. The outer shell 25 is provided at its bottom with an attachment tab 251 that can be bonded to the decorative cover 40 with a low melting-point metal, such as tin alloy. In a fire emergency, the low melting-point metal can be melted, and this will cause the decorative cover 40 to fall down and thus enable a large amount of high-temperature air to pass the outer shell 25 to contact the glass bulb 30, causing the heat-activated glass bulb 30 to break. Consequently, the cap fitted in the outlet 212 of the passage 21 will fall down, and thus the water supplied from the pipe 10 will flow out of the outlet 212 of the passage 21.

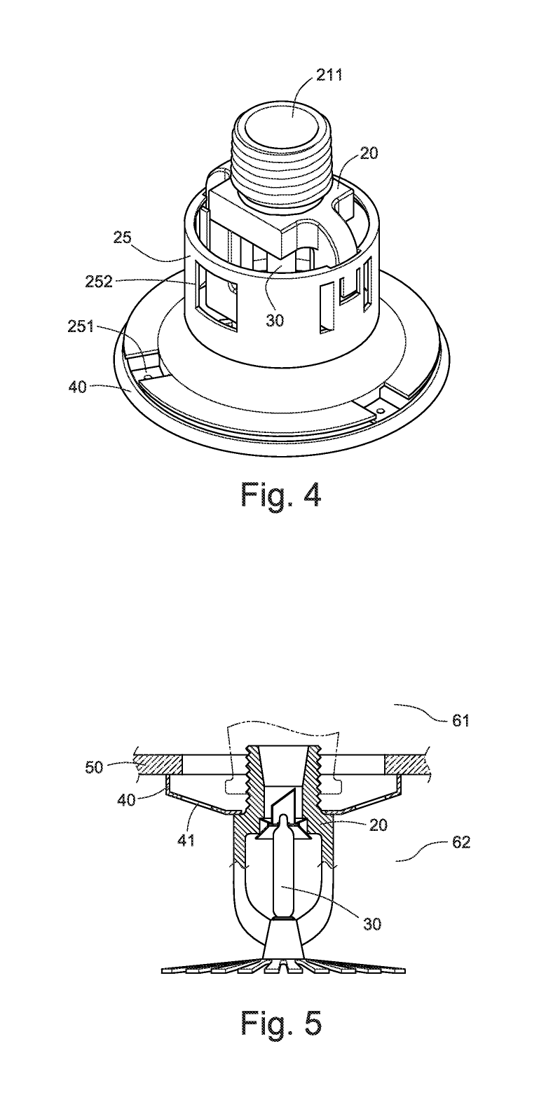

FIG. 4 shows a second embodiment of the present invention, wherein the outer shell 25 defines at least one ventilation hole 252, which can take shape through a punching operation, to facilitate the hot air in the upper compartment 61 to contact the heat-activated glass bulb 30. Generally, the ventilation hole 252 of the outer shell 25 can be configured to have any geometric shape. For example, the ventilation hole 252 can be shaped as a round hole, a square hole, a rectangular hole, or a plurality of mesh holes. In FIG. 4, the ventilation hole 252 is shaped as a square hole. The ventilation hole 252 can speed up the hot air in the upper compartment 61 passing the outer shell 25 to contact the heat-activated glass bulb 30 to allow the temperature of the glass bulb 30 to be increased rapidly. Consequently, the time required for breaking the glass bulb 30 can be shortened, so that the capability of the fire sprinkler to detect a high temperature can be increased.

FIG. 5 shows a third embodiment of the present invention, wherein the valve body 20 is substantially mounted in the lower compartment 62 and the heat-activated glass bulb 30 is exposed in the lower compartment 62. The covering means 40 is made in the form of a bell-shaped decorative cover mounted between the heat-activated glass bulb 30 and the suspended ceiling 50. The bell-shaped decorative cover 40 can seal an opening of the suspended ceiling 50 being provided for the water supply pipe 10. The upper compartment 61 and the lower compartment 62 can communicate with each other via the through hole 41. As such, when a fire emergency occurs, the through hole 41 can increase the air communication between the upper compartment 61 and the lower compartment 62, so that the capability of the heat-activated glass bulb 30 to respond to a high temperature can be increased.

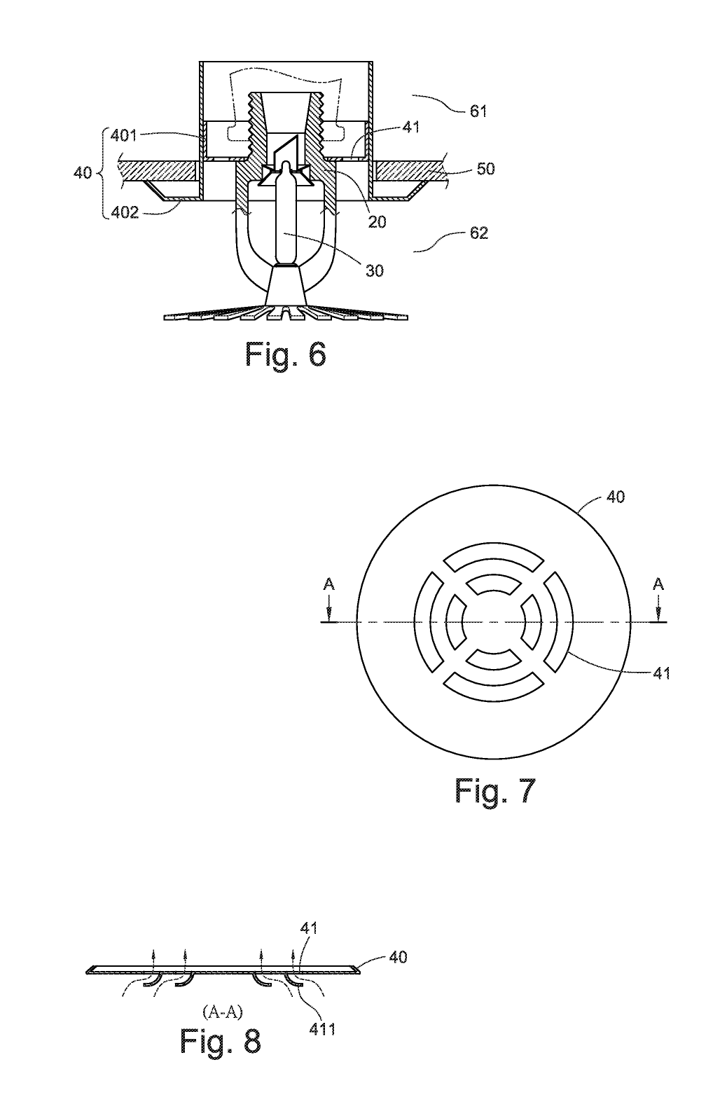

FIG. 6 shows a fourth embodiment of the present invention, wherein the covering means 40 includes an inner cover 401 and an outer cover 402 which encases the inner cover 401, the inner cover 401 defining at least one through hole 41 so that the upper compartment 61 and the lower compartment 62 communicate with each other. The inner cover 401 is engaged with the valve body 20 whereas the outer cover 402 is adjustably engaged with the inner cover 401. In installation, the position of the outer cover 402 relative to the inner cover 401 can be adjusted according to the height of the suspended ceiling 50. Therefore, the outer cover 402 can be properly fitted with the suspended ceiling 50 by adjusting the outer cover 402, so that the overall appearance of the suspended ceiling 50 can be improved.

Referring to FIGS. 7 and 8, the decorative cover 40 used in the present invention is provided with an air-guiding plate 411 for each through hole 41. Each air-guiding plate 411 can be provided through a punching process. As shown in FIG. 8, each air-guiding plate 411 extends downwardly from an edge of a corresponding through hole 41. Each air-guiding plate 411 can facilitate the hot air in the lower compartment 62 to aim at its corresponding hole 41, so that the hot air passing the decorative cover 40 via the through hole 41 can be increased.

In light of the foregoing, the present invention employs a covering means 40 and an outer shell 25, which are respectively defined with a through hole 41 and a ventilation hole 252, to increase ventilation within a room. With such features, when a fire emergency occurs, due to hot air being able to flow upward and being able to flow from a high pressure zone to a low pressure zone, the hot air generated in the lower compartment 62 will rapidly flow from the lower compartment 62 to the upper compartment 61, so that the capability of the heat-activated glass bulb 30 to respond to a high temperature can be increased, and thus the time required for activating the fire sprinkler to spray water can be reduced.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A fire sprinkler, which comprises:
a water supply pipe;
a valve body defining a passage that has an inlet and an outlet at two ends thereof, the inlet of the passage being connected with the water supply pipe;
a heat-activated glass bulb mounted in the valve body, wherein the heat-activated glass bulb is capable of closing the outlet of the passage when in normal condition; and
a covering means being arranged at a periphery of the valve body, wherein the covering means defines at least one through hole that facilitates the hot air generated in a fire emergency to contact the heat-activated glass bulb.

2. The fire sprinkler of claim 1, which is installed to cooperate with a suspended ceiling that separates a mom into an upper compartment and a lower compartment, wherein the valve body is substantially mounted in the upper compartment whereas the covering means is arranged in the lower compartment and adjacent to a bottom of the valve body, whereby the through hole of the covering means facilitates the hot air in the lower compartment to contact the heat-activated glass bulb.

3. The fire sprinkler of claim 2, which further comprises an outer shell being mounted around the valve body for protecting the heat-activated glass bulb, wherein the outer shell is bonded to the covering means through a low melting-point metal provided between a bottom of the outer shell and the covering means.

4. The fire sprinkler of claim 3, wherein the outer shell defines at least one ventilation hole that facilitates the hot air in the upper compartment to contact the heat-activated glass bulb.

5. The fire sprinkler of claim 1, which is installed to cooperate with a suspended ceiling that separates a mom into an upper compartment and a lower compartment, wherein the valve body is substantially mounted in the lower compartment and the heat-activated glass bulb is exposed in the lower compartment, and the covering means is made in the form of a bell-shaped decorative cover being mounted between the heat-activated glass bulb and the suspended ceiling

6. The fire sprinkler of claim 1, which is installed to cooperate with a suspended ceiling that separates a mom into an upper compartment and a lower compartment, wherein the covering means includes an inner cover and an outer cover which encases the inner cover, wherein the inner cover is engaged with the valve body whereas the outer cover is adjustably engaged with the inner cover.

7. The fire sprinkler of claim 1, wherein the through hole of the covering means is configured to have a geometrical shape.

8. The fire sprinkler of claim 7, wherein the covering means is formed with an air-guiding plate extending downwardly from an edge of the through hole for guiding the hot air generated in a fire emergency to pass the covering means via the through hole.

9. The fire sprinkler of claim 4, wherein the ventilation hole of the outer shell is configured to have a geometric shape.
